(19) United States
(12) Patent Application Publication
(10) Pub. No.: US 2007/0101635 A1
(43) Pub. Date: May 10, 2007

(54) FISHING LURE

(76) Inventor: Edkor David Rike, Lewisberg, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/163,992

(22) Filed: Nov. 7, 2005

(51) Int. Cl. A01K 85/00

(52) U.S. Cl. 43/42.06; 43/42.47

(57) ABSTRACT

A lure includes a hollow body having tongue extending forwardly from the body to which a fishing line can be attached and the body includes a hook attached thereto, an inlet channel is defined in the body and communicably connects a bladed wheel chamber which houses a multi-bladed wheel which rotates about an axis generally transverse to a flow path from the inlet channel through the blade chamber and out an outlet channel which communicates with the blade chamber.

### FIELD OF THE INVENTION

This invention relates to fishing lures and more particularly to a fishing lure which is retained and pulled by attachment to a fishing line controlled by the user.

Such lures have been used for many years in place of live bait for either cost purposes or with the belief that such lure offers advantages in attracting fish more readily than live bait, i.e., the belief that certain artificial baits may be as or more appealing to certain fish or certain fish-situations than live bait. These beliefs precipitate an annual surge in production of various lure types and are common instruments in modern fishing accessories.

Common features of a lure include a hook(s) and a body which serves as the attracting feature enabling hooking of the fish. The hook and body design vary widely in design shape, number and weight which in turn affects the lure's ability to be readily cast as well propelled through the water. The lure's structural and aesthetic features are thought to provide the basis for drawing in the fish to strike the lure and be thereby caught.

Other improvements on lures include spinners mounted on a shaft outside the body which permits complete rotation thereof when drawn through the water. The shape, speed and angle of spinner blades vary. Some spinners rotate slowly and others fast. Still other lures produce noise via the spinners as they rotate.

The sport continuously begs for a new lure design which attracts fish. Prior lure designs include various hooks, size, shape, color, and change in coloration, water channeling, and movement. While such lures continue to improve the art, the present invention provides still another improvement over the art. This is the aim of the present invention wherein lure's structural and aesthetic features are thought to provide an improvement over the prior lures.

### SUMMARY OF THE INVENTION

It is an object to improve fishing lures.

It is a further object to provide a fishing lure with increased action when pulled through water.

It is another object to provide a fishing lure with a novel toggle action when pulled through water.

It is yet another object to provide a fishing lure with unique water flow through the lure via a bladed wheel and channel design when pulled through water.

Accordingly, the present invention is directed to a novel fishing lure. The lure includes a hollow body having tongue extending forwardly from the body to which a fishing line can be attached. The body also includes a hook attached thereto. Proximate the point of connection of the tongue to a front of the body there is an inlet channel defined in the body. The inlet channel communicably connects to a bladed wheel chamber which houses a multi-bladed wheel which is disposed within the bladed wheel chamber to rotate about an axis generally transverse to a flow path from the inlet channel through the blade chamber. There is an outlet channel defined in a bottom of the body which communicates with the bladed wheel chamber. The inlet channel can be configured within the body to communicate with a portion of the bladed wheel chamber such that the flow path is introduced to the bladed wheel chamber on one side of the axis to force against a blade extending from the multi-bladed wheel and cause rotation thereof as the flow path continues through the outlet channel. The body can be translucent and the multi-bladed wheel surface can be colored, reflective, or luminescent, to create a desired attractive appearance within the body. The outlet channel can be relatively smaller than the inlet channel and chamber such that a Venturi effect can be created. The tongue can be pitched downwardly relative to a horizontal axis of the body. The body can be configured with any desired head end and tail end to resemble desired bait.

The present invention provides novel lure—which includes variable dynamics in color, motion and by appearance as a fish would see the lure. The dynamics are in part brought into being by pulling the lure through water.

### BRIEF DESCRIPTION OF THE DRAWINGS

FIG. 1 is a side view of the lure of the invention.

FIG. 2 is a bottom view of the lure of the invention.

FIG. 3 is a sectional view of the lure of the invention taken through line 3-3 in FIG. 2.

FIG. 4 is a front view of the lure of the invention.

FIG. 5 is a perspective sectional view of the lure of the invention.

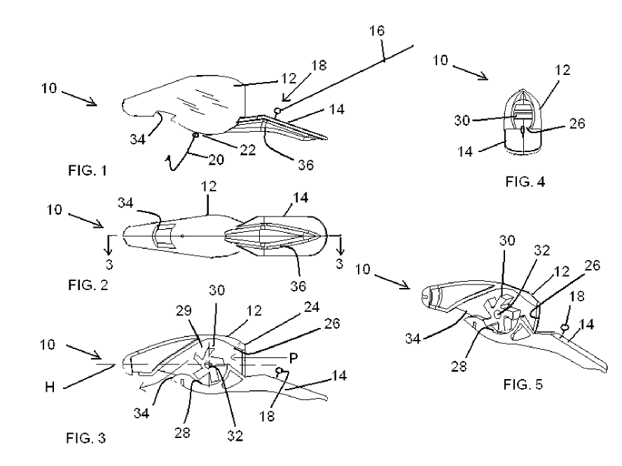

### DETAILED DESCRIPTION OF ILLUSTRATIVE EMBODIMENTS

Referring now to the drawings, the lure of the present invention is generally designated by the numeral 10. The lure 10 includes a hollow body 12 having tongue 14 extending forwardly from the body 12 to which a fishing line 16 can be attached to a connector 18 on the tongue 14. The tongue 14 can be angled or pitched to downwardly extend relative to a horizontal axis H of the body 12.

The body 12 includes a hook 20 which can be attached to a bottom 22 of the body 12. Proximate the point of connection of the tongue 14 to a front portion 24 of the body 12 there is an inlet channel 26 defined in the body 12 to receive water therethrough. The inlet channel 26 communicably connects to a bladed wheel chamber 28 which houses a multi-bladed wheel 30. The bladed wheel 30 is disposed within the blade chamber 28 to rotate about a hub bearing surface 32 extending inwardly from the body 12 on an axis generally transverse to a flow path P from the inlet channel 26 through the bladed wheel chamber 28. The bladed wheel chamber 28 can be generally configured with arcuate portions as seen in the FIGS. 3 and 5 to receive the bladed wheel 30.

There is an outlet channel 34 defined in the bottom 22 of the body 12 which communicates with the bladed wheel chamber 28. The inlet channel 26 can be configured as seen in FIGS. 3 and 5 within the body 12 to define a path to communicate with an upper portion 29 of the bladed wheel chamber 28 such that the flow path P is introduced to the bladed wheel chamber 28 generally on one side of the axis upon which the wheel 30 rotates. The force of the water along path P against a blade which extends from the multi-bladed wheel 30 causes rotation of the wheel 30 as the flow path P continues through the outlet channel 34.

The body 12 can be translucent and the multi-bladed wheel surface can be colored, reflective, or luminescent, to create a desired attractive appearance within the body 12. The outlet channel 34 can be relatively smaller than the inlet channel 26 and wheel chamber 28 such that a Venturi effect can be created. This restriction contributes to a unique wobble effect when pulling the lure 10 through the water during reeling. Also, in this regard, the downward tipped tongue 14 aids in direction of the water flow path P being maintained through the body 12 as it moves through or along the water surface. It is recognized that the body 12 can be configured with a desired head end and tail end to resemble desired bait. The bottom of the tongue 14 can be provided with a rib structure 36 which not only supportively connects to the body 12, but aids in the action of the lure 10 through the water.

The body 12 can be made of a plastic material, and can preferably be translucent at least about the bladed wheel chamber 30. In this regard, the rotation of the bladed wheel 30 is thought to provide a novel movement which attracts fish. The bladed wheel 30 can be of various color, reflectivity and luminescence to accommodate this desire. Also, the body 12 can include various color schemes to provide desired appearance of a bait. The dynamics of the invention is thus brought into being by pulling the lure 10 through water attracting fish as it moves through the water with its unique wobble effect.

The novel fish lure according to the invention provides a desired and advantageous lure, yielding the advantages of effects of movement, color and appearance by novel means intended to attract fish. Accordingly, it will thus be seen from the foregoing description of the invention according to these illustrative embodiments, considered with the accompanying drawings, that the present invention provides new and useful concepts in combination, which provide and achieve a novel and advantageous fish lure and accomplishing the intended objects, including those hereinbefore pointed out and others which are inherent in the invention. The location of the hook 20 and line connector 18 are intended to aid in the performance of the objects described herein. However, it is contemplated other locations may be found suitable to accomplish the objects and permit the lure to function as described. Modifications and variations may be effected without departing from the scope of the novel concepts of the invention; accordingly, the invention is not limited to the specific embodiments or form or arrangement of parts herein described or shown.

What is claimed is:

1. A novel fishing lure, which includes: a hollow body having tongue extending forwardly from the body to which a fishing line can be attached, a hook connected to said lure, an inlet channel, a bladed wheel chamber communicably connected to said inlet channel, an outlet channel communicably connected to said bladed wheel chamber, and a bladed wheel rotatably disposed within said bladed wheel chamber, a tongue connected to said body proximate a point of connection of said tongue to a front of said body.

2. The fishing lure of claim 1, wherein said bladed wheel is characterized to be a multi-bladed wheel.

3. The fishing lure of claim 1, wherein said bladed wheel is disposed within said bladed wheel chamber in a manner to rotate about an axis generally transverse to a flow path from said inlet channel through said blade chamber and outlet channel.

4. The fishing lure of claim 3, wherein said inlet channel is configured within said body to communicate with a portion of said bladed wheel chamber such that said flow path is introduced to said bladed wheel chamber on one side of said axis to force against a blade of said bladed wheel and cause rotation thereof.

5. The fishing lure of claim 1, wherein said body is translucent and said bladed wheel includes one of a colored, a reflective, and a luminescent surface.

6. The fishing lure of claim 1, wherein said outlet channel is relatively smaller than said inlet channel and said bladed chamber such that a Venturi effect is created.

7. The fishing lure of claim 1, wherein said tongue is pitched downwardly relative to a horizontal axis of said body.

8. The fishing lure of claim 1, wherein said outlet channel is in a bottom of said body.

9. The fishing lure of claim 1, wherein said body is configured with a predetermined bait head end and bait tail end to resemble desired bait.

10. A novel fishing lure, which includes: a hollow body having tongue extending forwardly from the body to which a fishing line can be attached, a hook connected to said lure, an inlet channel, a bladed wheel chamber communicably connected to said inlet channel, an outlet channel communicably connected to said bladed wheel chamber, and a bladed wheel rotatably disposed within said bladed wheel chamber, and wherein said body is translucent and said bladed wheel includes one of a colored, a reflective, and a luminescent surface.

11. The fishing lure of claim 10, wherein said bladed wheel is characterized to be a multi-bladed wheel.

12. The fishing lure of claim 10, wherein said bladed wheel is disposed within said bladed wheel chamber in a manner to rotate about an axis generally transverse to a flow path from said inlet channel through said blade chamber and outlet channel.

13. The fishing lure of claim 12, wherein said inlet channel is configured within said body to communicate with a portion of said bladed wheel chamber such that said flow path is introduced to said bladed wheel chamber on one side of said axis to force against a blade of said bladed wheel and cause rotation thereof.

14. The fishing lure of claim 10, wherein said outlet channel is in a bottom of said body.

15. The fishing lure of claim 10, which includes a tongue connected to said body proximate a point of connection of said tongue to a front of said body.

16. The fishing lure of claim 14, wherein said tongue is pitched downwardly relative to a horizontal axis of said body.

17. The fishing lure of claim 10, wherein said outlet channel is relatively smaller than said inlet channel and said bladed chamber such that a Venturi effect is created.

18. The fishing lure of claim 10, wherein said body is configured with a predetermined bait head end and bait tail end to resemble desired bait.

19. A novel fishing lure, which includes: a hollow body having tongue extending forwardly from the body to which a fishing line can be attached, a hook connected to said lure, an inlet channel, a bladed wheel chamber communicably connected to said inlet channel, an outlet channel communicably connected to said bladed wheel chamber, and a bladed wheel rotatably disposed within said bladed wheel chamber, and wherein said bladed wheel is disposed within said bladed wheel chamber in a manner to rotate about an axis generally transverse to a flow path from said inlet channel through said blade chamber and outlet channel.

20. The fishing lure of claim 19, wherein said inlet channel is configured within said body to communicate with a portion of said bladed wheel chamber such that said flow path is introduced to said bladed wheel chamber on one side of said axis to force against a blade of said bladed wheel and cause rotation thereof.

21. The fishing lure of claim 19, wherein said body is translucent and said bladed wheel includes one of a colored, a reflective, and a luminescent surface.

22. The fishing lure of claim 19, wherein said bladed wheel is characterized to be a multi-bladed wheel.

23. The fishing lure of claim 19, which includes a tongue connected to said body proximate a point of connection of said tongue to a front of said body.

24. The fishing lure of claim 23, wherein said tongue is pitched downwardly relative to a horizontal axis of said body.

25. The fishing lure of claim 19, wherein said outlet channel is relatively smaller than said inlet channel and said bladed chamber such that a Venturi effect is created.

26. The fishing lure of claim 19, wherein said outlet channel is in a bottom of said body.
